(19) United States
(12) Patent Application Publication
(10) Pub. No.: US 2011/0032789 A1
(43) Pub. Date: Feb. 10, 2011

(54) EMULSION MANUFACTURING EQUIPMENT

(76) Inventor: Toshiharu Fukai, Nagano (JP)

Correspondence Address: WENDEROTH, LIND & PONACK, L.L.P., 1030 15th Street, N.W.,, Suite 400 East, Washington, DC, 20005-1503, US

(21) Appl. No.: 12/922,883

(22) PCT Filed: Mar. 3, 2009
(86) PCT No.: PCT/JP2009/053914

§ 371 Date: Oct. 18, 2010

(30) Foreign Application Priority Data
Apr. 11, 2008 (JP) 2008-103944

(51) Int. Cl. B01F 13/06; B01F 3/12

(52) U.S. Cl. 366/139

(57) ABSTRACT

[Object]To provide emulsion manufacturing equipment that can continuously produce and consume an emulsion, reduce a tank volume, and reduce production cost without need for an agitator.
[Solution]

The emulsion manufacturing equipment includes a primary tank 10 having formed therein a main space 12, and a secondary tank 16 having formed therein a space for emulsification promotion 18, communicating the main space 12. The main space 12 is communicated to a first negative pressure mixer 22 via a circulation passageway 28. The space for emulsification promotion 18 includes therein the first negative pressure mixer 22, and an emulsion is introduced into the first negative pressure mixer 22 through the circulation passageway 28. The negative pressure generated in the first negative pressure mixer 22 draws water, a fuel and an emulsifier into the first negative pressure mixer 22, thereby converting the water, fuel and emulsifier into an emulsion. The emulsion of the first negative pressure mixer 22 is injected to the space for emulsification promotion 18 of the secondary tank 16 to promote the emulsification of the emulsion, and then the emulsion is introduced into the main space 12.

### TECHNICAL FIELD

The present invention relates to emulsion manufacturing equipment for producing an emulsion produced by emulsifying oil and water.

### BACKGROUND ART

Conventionally, various emulsions are made by mixing oils, water and emulsifiers. Oils that are used include fuels, cooking oil, cosmetic oil, petroleum-based dry solvents, waste oil and waste cooking oil. Of emulsions, particularly, an emulsion fuel such as light oil, heavy oil, kerosene or gasoline, made by mixing water, a fuel and an emulsifier is widely known. In general, the production of an emulsion fuel involves emulsion fuel manufacturing equipment comprising a mixing tank, etc. for making an emulsion fuel using water and a fuel, and a large storage tank for storing the emulsion fuel produced (Patent Document 1).

Emulsion fuel manufacturing equipment includes an agitator within its mixing tank for mixing and emulsifying water, a fuel and an emulsifier, and agitates the water, fuel and emulsifier within the mixing tank using the agitator to produce an emulsion fuel. This agitator not only mixes water, a fuel and an emulsifier to produce an emulsion fuel, but plays the role of keeping the emulsified state long by agitating the emulsion fuel to be easily separated.

### Patent Document 1: Unexamined Japanese Patent Publication No. 2001-323288

### DISCLOSURE OF THE INVENTION

### Problem to be Solved by the Invention

Up to now, for producing an emulsion fuel, water, a fuel and an emulsifier are placed in a large-scale mixing tank and then the water, the fuel and the emulsifier in the mixing tank are agitated by an agitator to produce a large amount of emulsion fuel. Thereafter, the emulsion fuel made in a large amount is transferred to a large storage tank, and the emulsion fuel is optionally fed from the storage tank to a burner or the like. That is, the production of an emulsion fuel needs space for two kinds of large-scale tanks comprising a large-scale mixing tank for efficiently manufacturing it in a large amount (production tank) and a large storage tank for storing an emulsion fuel produced.

Moreover, an agitator is needed to emulsify water, a fuel and an emulsifier efficiently in a mixing tank when an emulsion fuel is manufactured. In addition, an emulsion fuel stored in a storage tank has the fear of separation in a short term, so that the storage tank also includes an agitator therein in order to keep an emulsified state of the emulsion fuel in the storage tank.

The present invention solves the above problems, and its object is to provide emulsion manufacturing equipment that can simultaneously and continuously produce and consume an emulsion, reduce a tank volume to achieve space saving, and reduce production cost without need for an agitator.

### Means for Solving the Problems

Emulsion manufacturing equipment according to the present invention characteristically includes: a primary tank having formed therein a main space for storing an emulsion; a secondary tank having formed therein a space for emulsification promotion communicating with the main space; a circulation passageway communicating with the main space at one end and for circulating and moving an emulsion within the main space; transfer means provided in the middle of the circulation passageway and for moving the emulsion within the main space through the circulation passageway; a liquid introduction channel communicating with a water tank and an oil tank at one end and passing water and oil; and a first negative pressure mixer disposed within the space for emulsification promotion of the secondary tank, and including a mixing space communicating with another end of the circulation passageway and mixing the emulsion introduced from the circulation passageway with the water and oil introduced from another end of the liquid introduction channel, and a first nozzle injecting the emulsion from the circulation passageway to the mixing space to generate a negative pressure in the mixing space. The present invention characteristically includes: a second negative pressure mixer comprising a housing, a mixing space formed inside the housing, a first nozzle for introducing the emulsion from the circulation passageway into the mixing space and an inlet communicating the mixing space to the outside of the housing, within the main space of the primary tank. The present invention is characterized in that the secondary tank includes a container shape having an opening formed in the upper part, the secondary tank is disposed downward of the bottom of the primary tank, and the secondary tank is connected and fixed to the bottom of the primary tank at an upper opening edge thereof. The present invention is characterized in that the secondary tank includes a container shape having an opening formed in an upper part thereof, and is disposed within the main space of the primary tank. The present invention is characterized in that the first negative pressure mixer includes a second nozzle for injecting an emulsion mixed within the mixing space into the space for emulsification promotion. The present invention is characterized in that the main tank includes a lower limit sensor and an upper limit sensor, each sensor detecting the liquid level of an emulsion within the main space. The present invention is characterized in that the liquid introduction channel includes a water supply channel, an oil supply channel and an emulsifier supply channel which are branched on the way, in which the water supply channel communicates with the water tank, the oil supply channel communicates with the oil tank which stores oil, the emulsifier supply channel communicates with the emulsifier tank, the water supply channel includes a first on-off valve in the middle thereof which opens or closes the supply channel, the oil supply channel includes a second on-off valve in the middle thereof which opens or closes the supply channel, and the emulsifier supply channel includes a third on-off valve in the middle thereof which opens or closes the supply channel. The present invention characteristically includes a rock storage container storing therein a rock containing much silicon dioxide of igneous rocks downstream of the transfer means in the middle of the circulation passageway. The present invention is characterized in that the sizing of most rocks containing much silicon dioxide of the igneous rocks is from 5 mm to 50 mm. The present invention is characterized in that the rock containing much silicon dioxide of the igneous rocks includes obsidian.

### Advantages of the Invention

According to emulsion manufacturing equipment concerning the present invention, the emulsion within the main space of the primary tank is introduced into the first negative pressure mixer by the working of a pump, and emulsification is promoted in the first negative pressure mixer. Since the emulsion in which emulsification was promoted is further injected to a narrow space for emulsification promotion within the secondary tank, the stirring and mixing of the injected emulsion and the emulsion within the narrow space for emulsification promotion promotes further emulsification of the emulsion within the space for emulsification promotion. Moreover, the introduction of water, oil and an emulsifier into the first negative pressure mixer as well as continuation of the operation of the pump can sequentially form an emulsion within the first negative pressure mixer to sequentially inject the emulsion continuously from the first negative pressure mixer into the space for emulsification promotion. The emulsion injected into the space for emulsification promotion is forcibly stirred and mixed in the narrow space for emulsification promotion, so that the emulsification of the emulsion is promoted. The emulsion in which emulsification was promoted is extruded into the main space of the primary tank in a sequence from the inside of the space for emulsification promotion. Thus, since the emulsion made in the space for emulsification promotion is sufficiently agitated and mixed, it can be directly consumed. In other words, in the present invention, the production and consumption of an emulsion can be performed simultaneously and continuously. When the emulsion is consumed immediately after production, the amount of use of an emulsifier can be small. In addition, in the case where the emulsion is an emulsion fuel, when the emulsion fuel is consumed immediately after its production, a high combustion calorie can be obtained as compared with the case where the emulsion fuel is consumed one day after its production. Additionally, the secondary tank should be small for agitation and mixing of the emulsion, and in accordance with the secondary tank, the primary tank can be made small. As a result, the whole apparatus can be miniaturized, thereby being capable of reducing production cost as well as achieving space-saving.

The present invention further includes a first negative pressure mixer comprising a mixing space for sucking water, oil, and an emulsifier by negative pressure and a first nozzle for generating the negative pressure in the mixing space. Because of this, the invention can eliminate the need for a pump for introducing water, a fuel and an emulsifier into the primary tank since the first negative pressure mixer sucks water and oil by negative pressure, thereby being capable of reducing the production cost for apparatus. Moreover, water, a fuel, or an emulsifier, and an emulsion are mixed in the first negative pressure mixer, whereby an agitator conventionally needed can be eliminated, thereby being capable of reducing the production cost for apparatus. Further in the invention, an emulsion fuel within the main space of the primary tank is circulated through the first negative pressure mixer, the space for emulsification promotion, and the main space in the order via the circulation passageway (a pump and a rock storage container are included on the way). As a result, since the emulsion fuel can be made contact with a rock such as obsidian in the rock storage container for a long time, an emulsion that contains a large amount of dissolved oxygen and active hydrogen can be made in a short time. In addition, an emulsion fuel is circulated and made contact with rocks having many sharp edges formed on the surfaces many times, whereby the water and fuel making up the emulsion fuel are finely cut by a rock, thereby being capable of stabilizing the emulsified state.

The invention includes a second negative pressure mixer for mixing an emulsion in the main space with an emulsion passing through the circulation passageway, within the main space. The use of this second negative pressure mixer, when the blend ratio of the water, oil and emulsifier of an emulsion within the main space is not constant, makes mixed the ununiform emulsion within the main space and the emulsion passing through the circulation passageway, and then the mixed emulsion is injected toward the ununiform emulsion within the main space. This makes it possible to promote the uniformization of the emulsion within the main space.

### BRIEF DESCRIPTION OF THE DRAWINGS

FIG. 1 is a block diagram that shows a first example for emulsion manufacturing equipment according to the present invention.

FIG. 2 is an enlarged cross-sectional view for a main part of the emulsion manufacturing equipment in FIG. 1.

FIG. 3 is a sectional view for a first negative pressure mixer used in FIGS. 1 and 2.

FIG. 4 is a block diagram that shows a second example for emulsion manufacturing equipment according to the present invention.

### EXPLANATION OF REFERENCE NUMERALS

10: Primary tank
12: Main space
14: Bottom
16: Secondary tank
18: Space for emulsification promotion
20: Upper opening
22: First negative pressure mixer
24: Mixing space
28: Circulation passageway
30: First nozzle
32: Second nozzle
34: Liquid introduction channel
36: Liquid level
38: Lower limit sensor
40: Upper limit sensor
42: Water tank
44: Water supply channel
46: First on-off valve
48: Oil tank
50: Oil supply channel
52: Second on-off valve
54: Emulsifier tank
56: Emulsifier supply channel
58: Third on-off valve
60: Pump
62: Rock storage container
66: Branched passageway
68: Second negative pressure mixer
70: Inlet
76: Small tank
78: Upper opening
80: Space for emulsification promotion

### DESCRIPTION OF THE PREFERRED EMBODIMENTS

The present invention carries out the production and consumption of an emulsion simultaneously and continuously and makes tank capacity small to achieve space-saving and reduction of production cost.

### EXAMPLE 1

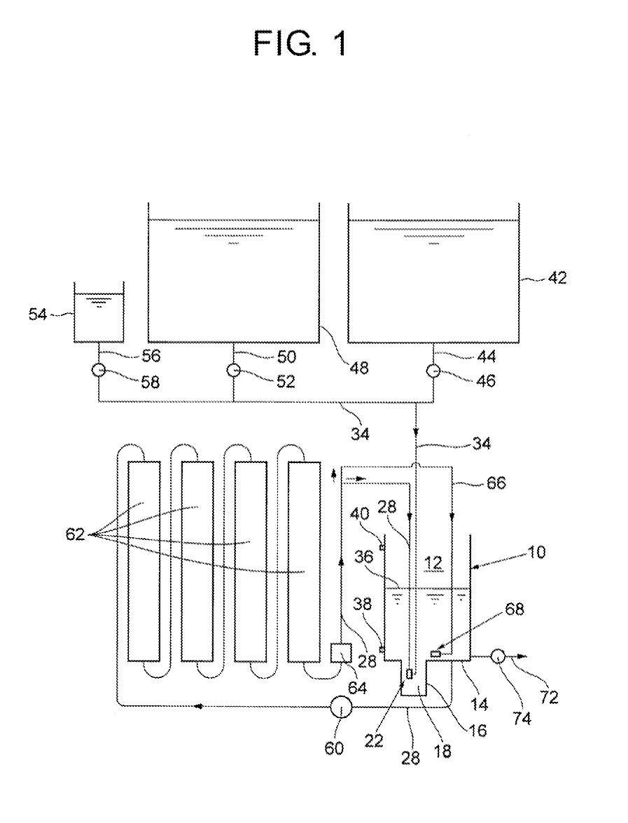

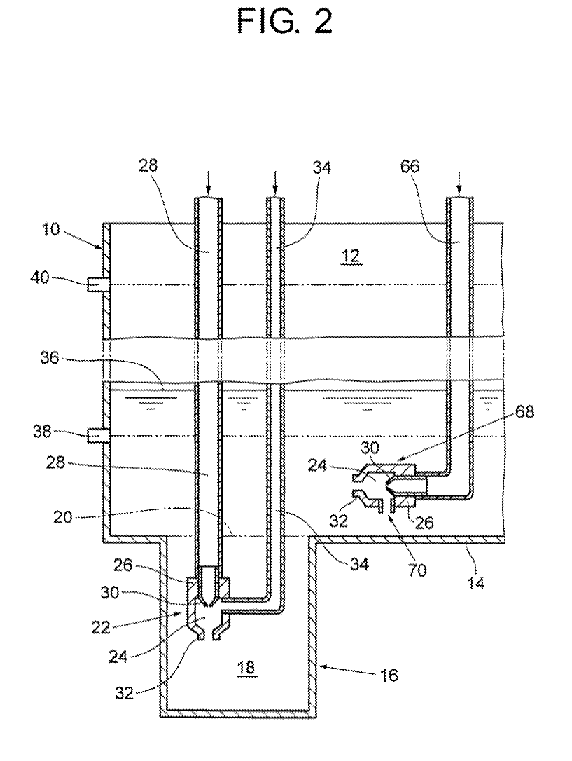

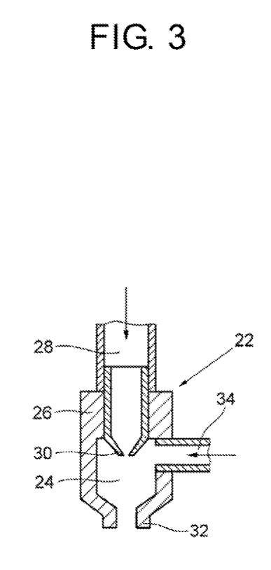

Hereafter, the present invention will be described with reference to the drawings. FIG. 1 is a block diagram that shows a first example for emulsion manufacturing equipment according to the present invention; FIG. 2 is an enlarged cross-sectional view of a main part of FIG. 1; and FIG. 3 is a sectional view for a negative pressure mixer used in FIGS. 1 and 2. An emulsion produced by the emulsion manufacturing equipment of the present invention will be set forth as an emulsion fuel below, using oil as a fuel (e.g., a fuel such as heavy oil, light oil, kerosene, or gasoline). An emulsion fuel is produced by mixing a fuel (e.g., a fuel such as heavy oil, light oil, kerosene, or gasoline), water (not only ordinary water, but optionally specific water containing, for example, much dissolved oxygen and active hydrogen that promote combustion for use) and an emulsifier (not only a chemical, but including vegetable oil for promoting emulsification).

Emulsion manufacturing equipment according to the present invention includes a primary tank 10 having a main space 12 formed therein. The primary tank 10 includes a container-shaped, secondary tank 16 protruding inferiorly from the bottom 14 of the primary tank, with the secondary tank 16 integrally fixed to the primary tank 10 by welding, for example. The space formed inside the secondary tank 16 is a space for emulsification promotion 18. The secondary tank 16 is attached to the bottom 14 of the primary tank 10 in the circumference of an upper opening 20 thereof. The space for emulsification promotion 18 communicates with the main space 12 via the upper opening 20 of the secondary tank 16 (shown with a chain double-dashed line in FIG. 2). The secondary tank 16 is in a closed state excluding the upper opening 20. Here, the volume of the main space 12 of the primary tank 10 (volume to the upper limit sensor described below) is set at ten liters for example, and the volume of space for emulsification promotion 18 of the secondary tank 16 is set, for example, at one liter. However, neither the volume of the primary tank 10 nor the volume of the space for emulsification promotion 18 is not limited thereto.

A first negative pressure mixer 22 is disposed inside the space for emulsification promotion 18. The first negative pressure mixer 22 is disposed inside the space for emulsification promotion 18 located downward of the bottom 14 of the primary tank 10, whereby even if the primary tank 10 ships, automobiles, etc. comprising the primary tank 10) inclines, the disadvantage of the first negative pressure mixer 22 not actuating is prevented to occur since air enters the first negative pressure mixer 22. Here, the first negative pressure mixer 22 will be described with reference to FIG. 3. The first negative pressure mixer 22 includes a housing 26 having a mixing space 24 formed therein, a first nozzle 30 for injecting an emulsion fuel from a circulation passageway 28 (details will be described below) into a mixing space 24, and a second nozzle 32 formed in the housing 26 and injecting an emulsion fuel within a mixing space 24 (details will be described below) into the space for emulsification promotion 18. Further to the housing 26 of the first negative pressure mixer 22 is communicated a liquid introduction channel 34 for introducing and passing a liquid (water, a fuel or emulsifier) from the outside into the mixing space 24.

In this first negative pressure mixer 22, the emulsion fuel injected from the first nozzle 30 into the mixing space 24 generates a negative pressure within the mixing space 24, and this negative pressure introduces water, a fuel and an emulsifier into the mixing space 24 from the liquid introduction channel 34. In this first negative pressure mixer 22, further, the force of the emulsion fuel injected from the first nozzle 30 into the mixing space 24 injects the emulsion fuel (details are described below) mixed in the space for emulsification promotion 18 from the second nozzle 32 to the outside (the space for emulsification promotion 18). The emulsion fuel injected from the second nozzle 32 to the space for emulsification promotion 18 is desirably injected toward the lowest face of the secondary tank 16 secluded site in the space for emulsification promotion 18).

As shown in FIGS. 1 and 2, the primary tank 10 includes a lower limit sensor 38 for detecting the lower limit of a liquid level 36 of the emulsion fuel within the primary tank 10 and an upper limit sensor 40 for detecting the upper limit of the liquid level 36 of the emulsion fuel within the primary tank 10. When the liquid level 36 of the emulsion fuel in the primary tank 10 descends and the lower limit sensor 38 detects the lower limit of the descent of the liquid level 36, water, a fuel and an emulsifier are introduced into the first negative pressure mixer 22 from the liquid introduction channel 34 to make an emulsion fuel which is then injected from the first negative pressure mixer 22 into the space for emulsification promotion 18, which raises the liquid level 36 of the emulsion fuel in the primary tank 10. Thereafter, when the liquid level 36 of the emulsion fuel within the primary tank 10 rises and the upper limit of the liquid level 36 is detected by the upper limit sensor 40, the feeding of water, a fuel and an emulsifier to the primary tank 10 is stopped.

The present invention includes, as shown in FIG. 1, a water tank 42 which stores water (not only ordinary water, but optionally specific water containing much dissolved oxygen, active hydrogen and the like to promote combustion for use), a water supply channel 44 from the water tank 42, and a first on-off valve 46 which opens or closes the water supply channel 44. The invention also includes a fuel tank (oil tank) 48 which stores a fuel (e.g., a fuel such as heavy oil, light oil, kerosene, or gasoline), a fuel supply channel (oil supply channel) 50 from the fuel tank 48, and a second on-off valve 52 which opens or closes the fuel supply channel 50. The invention further includes an emulsifier tank 54 which stores an emulsifier (e.g., including not only a chemical, but a vegetable oil for promoting emulsification), an emulsifier supply channel 56 from the emulsifier tank 54, and a third on-off valve 58 which opens or closes the emulsifier supply channel 56. The water supply channel 44 communicates with the liquid introduction channel 34 via the first on-off valve 46, the fuel supply channel 50 communicates with the liquid introduction channel 34 via the second on-off valve 52, and the emulsifier supply channel 56 communicates with the liquid introduction channel 34 via the third on-off valve 58. In principle, the first on-off valves 46, 52, 58 are operated such that water, a fuel, and an emulsifier are introduced into the liquid introduction channel 34 alone.

As shown in FIG. 1, to the primary tank 10 is connected one end of the circulation passageway 28 for introducing a liquid such as an emulsion fuel within the main space 12 of the primary tank 10 into the space for emulsification promotion 18. Another end of the circulation passageway 28 is connected, as shown in FIG. 2, to the first negative pressure mixer 22 included in the space for emulsification promotion 18. A pump 60, a rock storage container 62 and a filter 64 as transfer means for transferring a liquid such as an emulsion fuel are provided in sequence in the middle of the circulation passageway 28 from upstream (primary tank 10 side) toward downstream (first negative pressure mixer 22 side).

A rock containing much silicon dioxide of igneous rocks (rock containing about 65 to 76% of silicon dioxide) is stored in the rock storage container 62. The rock is desirably made, for example, a size of about 5 mm to 50 mm, placed in a net (not shown), and stored inside the rock storage container 62. As rocks containing much silicon dioxide of igneous rocks (classified into volcanic rocks and plutonic rocks), the volcanic rocks include rhyolites such as obsidian, pearlite and pitchstone, and the like, and the plutonic rocks include granite and the like. Among the igneous rocks, obsidian is desirably used from the viewpoints of inexpensiveness and easiness of acquisition. A liquid such as an emulsion fuel is desirably made contact with the rock for a long time. Because of this, although the length of the rock storage container 62 is needed to be large, it is rather desirable to divide the rock storage container 62 into many short cylinders (e.g., cylinders of a length of about 80 cm) from the viewpoints of device miniaturization and operability during replacement of rocks.

Most of rocks containing much silicon dioxide of igneous rocks are made a size of about 5 mm to 50 mm, whereby many sharp edges can be formed on the surface of the rock and also a liquid such as an emulsion fuel can be made contact with the surface of the rock in a large amount. An emulsion fuel is made contact with the rock in a state in which the system is highly pressurized by the pump 60, so that a large amount of dissolved oxygen and active hydrogen can be included in water making up a liquid such as an emulsion fuel. In addition, a liquid such as an emulsion fuel is passed through the rock on the surface of which are formed many sharp edges in a state in which the system is highly pressurized by the pump 60, whereby the sharp edge of the rock can further finely cut the liquid such as the emulsion fuel leading to the promotion of emulsification.

There is a fear that debris of rocks stored within the net of the rock storage container 62 flows out downstream of rock storage container 62. Therefore, the filter 64 is provided downstream of the rock storage container 62, whereby debris of the rock is prevented from entering the insides of the first negative pressure mixer 22 and the space for emulsification promotion 18.

As described above, the another end of the circulation passageway 28 is connected to the first negative pressure mixer 22 installed within the space for emulsification promotion 18 and is branched in the middle of the circulation passageway 28 after passing through the filter 64, and the branched passage is a branched passageway 66. To the tip of the branched passageway 66 is connected the second negative pressure mixer 68 installed in a lower part within the primary tank 10. This second negative pressure mixer 68 is disposed in a lower part than the height of the lower limit sensor 40. The second negative pressure mixer 68 uses the same structure as that of the first negative pressure mixer 22. The second negative pressure mixer 68 includes an opening 70 which communicates with the mixing space 24 at one edge and which communicates with the outside of the housing 26 (main space 12 of the primary tank 10) at another edge. The opening 70 is disposed in the lowest position in the second negative pressure mixer 68. The opening 70 of the second negative pressure mixer 68 is disposed in the lowest position in the second negative pressure mixer 68, whereby even if the primary tank 10 (ships, automobiles, etc. comprising the primary tank 10) inclines, the disadvantage of the first negative pressure mixer 22 not actuating is prevented to occur since air enters the second negative pressure mixer 68.

In the second negative pressure mixer 68, an emulsion fuel is injected from the branched passageway 66 into the mixing space 24 via the first nozzle 30. The emulsion fuel generates a negative pressure within the mixing space 24, and the negative pressure introduces the emulsion fuel in the primary tank 10 from the opening 70 into the mixing space 24. Within the mixing space 24, the emulsion fuel injected from the first nozzle 30 passed through the rock storage container 62) and the emulsion fuel drawn in from the opening 70 (emulsion fuel in the main space 12 of the primary tank 10) are mixed with each other, further promoting emulsification. Thereafter, the emulsion fuel which has been promoted in emulsification within the mixing space 24 is injected from the second nozzle 32 to the main space 12 of the primary tank 10. In addition, the second negative pressure mixer 68 may use a structure different from that of the first negative pressure mixer 22.

To a lower part of the primary tank 10 is connected a fuel supply pipe 72 for supplying the emulsion fuel within the primary tank 10 to a burner (not shown) or the like. An electromagnetic valve 74 for opening or closing the fuel supply pipe 72 is provided in the middle of the fuel supply pipe 72.

Now, the procedure for manufacturing an emulsion fuel by using emulsion manufacturing equipment of the present invention will be described. In an empty state of the primary tank 10, when the use of the emulsion manufacturing equipment of the present invention is initiated, water, a fuel and an emulsifier are charged into the primary tank 10 by man power (charged to a part higher than the lower limit sensor 38 and lower than the upper limit sensor 40). In addition, respective liquids are stored in sufficient amounts in the water tank 40, fuel tank 48 and emulsifier tank 54. Thereafter, the pump 60 is actuated. The water, fuel and emulsifier charged into the primary tank 10 by the actuation of the pump 60 are introduced into the circulation passageway 28 from the main space 12 of the primary tank 10 and highly pressurized by the pump 60 and then sent to the rock storage container 62. The water, fuel and emulsifier charged into the primary tank 10 are partially emulsified and become an emulsion fuel or become respective liquid masses without emulsification and then pass the rock storage container 62 through the circulation passageway 28. The emulsion fuel and the respective liquids make contact, at a high pressure, with the rock containing much silicon dioxide having many sharp edges formed on the surface within the rock storage container 62. The emulsion fuel and the water are made contact with a large amount of rock, whereby dissolved oxygen and active hydrogen can be included in the water making up an emulsion fuel. In addition, the rock having many sharp edges formed on the surface finely cuts the water and fuel making up the emulsion fuel, making the emulsified state further stable. Moreover, the water and the fuel which do not become an emulsion fuel are finely cut, thereby becoming a state of easily being an emulsion fuel.

The emulsion fuel which has passed the rock storage container 62 then reaches the first nozzle 30 of the first negative pressure mixer 22 via the circulation passageway 28, is injected to the mixing space 24 at a high pressure and a high speed from the first nozzle 30, and subsequently is injected to the space for emulsification promotion 18 via the second nozzle 32 from the mixing space 24. Injecting the emulsion fuel and the respective liquids (the water, fuel and emulsifier) to the mixing space 24 from the first nozzle 30 in the first negative pressure mixer 22 produces an emulsion fuel in the mixing space 24. In addition, an emulsion fuel is made by injecting the emulsion fuel or the water, the fuel and the emulsifier from the second nozzle 32 into the space for emulsification promotion 18. Since the space for emulsification promotion 18 is closed and also a narrow space except the upper opening 20, the emulsion fuel or the water, fuel and emulsifier injected from the second nozzle 32 to the narrow space for emulsification promotion 18 are mixed with the liquid within the space for emulsification promotion 18 to become an emulsion fuel. The emulsion fuel made in the space for emulsification promotion 18 is then continuously extruded from the space for emulsification promotion 18 to the upper main space 12 by the emulsion fuel which is newly injected from the second nozzle 32 of the first negative pressure mixer 22 and is produced. [0030]

The emulsion fuel extruded from the inside of the space for emulsification promotion 18 to the main space 12 repeats the circulation movement of the circulation passageway 28, the rock storage container 62, the first negative pressure mixer 22, the space for emulsification promotion 18, and the main space 12 in sequence again from the inside of the main space 12 by continuing the actuation of the pump 60. The water, the fuel, and the emulsifier first charged into the primary tank 10 become an emulsion fuel by repeating this circulation movement. Thus, the emulsion fuel is produced in the main space 12 of the primary tank 10 by actuating the pump 60 during a first specified time.

The water, the fuel, and the emulsifier charged into the main tank 10 completely become an emulsion fuel, and then the emulsion fuel is taken out of the main tank 10 through the fuel supply channel 72 and consumed. Fuel supply from the fuel supply channel 72 to a burner or the like lowers the liquid level 36 within the primary tank 10, so that the lower limit sensor 38 detects the lower limit of the liquid level 36. After the lower limit of the liquid level 36 by the lower limit sensor 38 is detected, the water from the water tank 40, the fuel from the fuel tank 48, and the emulsifier from the emulsifier tank 54 are introduced into the mixing space 24 of the first negative pressure mixer 22 via the liquid introduction channel 34. In this case, the water, the fuel, and the emulsifier are introduced alone in sequence one by one from once to several times into the mixing space 24. Further, the order of the introduction of the water, the fuel, and the emulsifier is not limited thereto.

Within the mixing space 24 of the first negative pressure mixer 22, the emulsion fuel flowed through the circulation passageway 28 and the rock storage container 62 is injected from the first nozzle 30 by the pump 60. Injecting the emulsion fuel injected from the first nozzle 30 to the mixing space 24 generates a negative pressure within the mixing space 24. When the negative pressure generated within the mixing space 24 arrives at the liquid introduction channel 34, and the first on-off valve 46, the second on-off valve 52 and the third on-off valve 58 are each opened, the water, the fuel, and the emulsifier are drawn independently into the mixing space 24 by the negative pressure within the mixing space 24. The water, the fuel, and the emulsifier drawn into the mixing space 24 are mixed with the emulsion fuel injected from the first nozzle 30 to the mixing space 24, sequentially becoming an emulsion fuel. The emulsion fuel produced in the mixing space 24 is then injected into the space for emulsification promotion 18 from the second nozzle 32 and becomes an emulsion fuel further promoted in emulsification within the space for emulsification promotion 18 in a narrow closed state.

The water from the water tank 40, the fuel from the fuel tank 48, and the emulsifier from the emulsifier tank 54 are introduced into the first negative pressure mixer 22, whereby an emulsion fuel is injected sequentially into the space for emulsification promotion 18 from the second nozzle 32. An emulsion fuel is sequentially supplied into the space for emulsification promotion 18, whereby an emulsion fuel is extruded sequentially into the main space 12 from the space for emulsification promotion 18, thereby raising the liquid level 36 within the primary tank 10. Here, the amount for each unit time of the emulsion fuel within the primary tank 10 taken out of the fuel supply channel 72 to the outside is set at a smaller value than the amount for each unit time of the water, the fuel or the emulsifier supplied to the first negative pressure mixer 22. As a result, the liquid level 36 in the primary tank 10 rises even if the emulsion fuel in the primary tank 10 is continuously taken out of the fuel supply channel 72 to the outside.

When the liquid level 36 of the emulsion fuel within the primary tank 10 rises and the liquid level 36 is detected by the upper limit sensor 40, the feeding of the water from the water tank 40, the fuel from the fuel tank 48 and the emulsifier from the emulsifier tank 54 is stopped. As the emulsion fuel within the primary tank 10 is continuously taken out, the liquid level 36 of the emulsion fuel in the primary tank 10 keeps descending. The pump 60 is actuated when the liquid level 36 descends, and the emulsion fuel in the primary tank 10 repeats the circulation movement of the circulation passageway 28, the rock storage container 62, the first negative pressure mixer 22, the space for emulsification promotion 18, and the main space 12 within the primary tank 10, in sequence. Repetition of this circulation movement promotes the emulsification of the emulsion fuel in the primary tank 10 and adds dissolved oxygen and active hydrogen to the emulsion fuel. Thereafter, when the descent to the lower limit of the liquid level 36 is detected by the lower limit sensor 38, water, a fuel and an emulsifier are in a sequence introduced again into the mixing space 24 of the first negative pressure mixer 22. Thus, when the emulsion fuel causes a shortage problem, water, a fuel and an emulsifier are additionally supplied, so that an emulsion fuel can be continuously produced while continuously consumed.

The emulsion fuel overflowed from the space for emulsification promotion 18 into the main space 12 does not have a constant emulsion fuel mixing ratio; there are the cases of the water content being high, the fuel content being high, and the emulsifier content being high, which are repeated in sequence. In other words, in the emulsion fuel overflowed from the space for emulsification promotion 18 into the main space 12, the blend ratio of the water to the fuel to the emulsifier is changed sequentially. However, even if the blend ratio of the water to the fuel to the emulsifier changes sequentially, the emulsion fuel which overflows from the space for emulsification promotion 18 into the main space 12 is then mixed with the emulsion fuel within the main space 12. Subsequently, the difference between the increase and decrease of the blend ratio of the water to the fuel to the emulsifier almost disappears, and the emulsion fuel with few difference between the increase and decrease of the blend ratio of the water to the fuel to the emulsifier is supplied to a burner or the like.

When the blend ratio of an emulsion fuel supplied to a burner from the main space 12 of the primary tank 10 via the fuel supply pipe 72 is different in every case, there are fears that the combustion becomes unstable and the fire goes out. The emulsion fuel produced by using specific water devised by the present inventor can be surely combusted even if the content of the water is greatly changed. However, when a conventionally known emulsion fuel the water content of which, for example, is increased is supplied to a burner, there is a fear that fire goes out.

Because of this, the blend ratio of the emulsion fuel in the main space 12 is made uniform by using the second negative pressure mixer 68 installed in the main space 12. The emulsion fuel passing through the rock storage container 62 and the branched passageway 66 is injected to the mixing space 24 of the second negative pressure mixer 68 via the first nozzle 30, and a negative pressure is generated in the mixing space 24. The negative pressure within the mixing space 24 introduces into the mixing space 24 from the inlet 70 the emulsion fuel within the main space 12 (emulsion fuel in which the water content is high, the content of the fuel is high, or the content of the emulsifier is high), and the emulsion fuel is mixed with an emulsion fuel passing through the branched passageway 66 (circulation passageway 28) within the mixing space 24, so that the blend ratio of the water to the fuel to the emulsifier is made uniform. In addition, the emulsion fuel in which the blend ratio of water to a fuel to an emulsifier is made uniform within the mixing space 24 is injected from the second nozzle 32 toward the emulsion fuel within the main space 12. As a result, even if the emulsion fuel overflowed from the space for emulsification promotion 18 into the main space 12 has a high water content, a high fuel content or a high emulsifier content, the blend ratio of water to a fuel to an emulsifier in the emulsion fuel can be made uniform, capable of eliminating the fear that the fire for the emulsion fuel goes out.

In the present invention, since the emulsion fuel is injected from the second nozzle 32 of the first negative pressure mixer 22 to the narrow space for emulsification promotion 18 closed except one end, an emulsion fuel within the space for emulsification promotion 18 is agitated, whereby the emulsification of the emulsion fuel can be promoted further. Even though materials not emulsified are left in the liquid injected from the second nozzle 32 or the liquid within the space for emulsification promotion 18, they are agitated within the space for emulsification promotion 18, so that an emulsion fuel can be surely made. Since the space for emulsification promotion 18 communicates with the main space 12 of the primary tank 10 and the emulsion fuel is continuously injected from the first negative pressure mixer 22 into the space for emulsification promotion 18, the emulsion fuel agitated in the space for emulsification promotion 18 (emulsion fuel emulsified in a state capable of being supplied to a burner or the like) is extruded in a sequence from the space for emulsification promotion 18 into the main space 12 of the primary tank 10 and mixed with the emulsion fuel within the main space 12. The emulsion fuel not consumed among the emulsion fuel within the main space 12 is circulated by the pump 60 and injected again to the space for emulsification promotion 18 from the first negative pressure mixer 22.

The volume of the space for emulsification promotion 18 within the secondary tank 16 is reduced to further promote the stirring and mixing of the emulsion fuel injected into the space for emulsification promotion 18. The emulsion fuel which overflows from the space for emulsification promotion 18 into the main space 12 of the primary tank 10 can be directly supplied to, and consumed in, a burner or the like, the volume of the main space 12 of the primary tank 10 can also be made small by considering the primary tank 10 to be a supply channel. That is, since the primary tank 10 of the invention differs from a conventional storage tank and is used as a passageway for supplying to a burner or the like the emulsion fuel injected into the space for emulsification promotion 18, a particularly large volume is not needed. As a result, the primary tank 10 and the secondary tank 16 can be settled by using a small volume tank in the present invention, so that space saving can be achieved.

In the present invention, in the first negative pressure mixer 22 installed within the space for emulsification promotion 18, an emulsion fuel highly pressurized by the pump 60 is injected into the mixing space 24 from the first nozzle 30 to generate a negative pressure within the mixing space 24 and then to utilize the pressure, drawing water, a fuel and an emulsifier into the first negative pressure mixer 22. Thus, the invention can eliminate the need for a pump for introducing water, a fuel and an emulsifier into the primary tank 10, thereby reducing the production cost for apparatus. In addition, since the emulsion fuel can be sufficiently agitated within the space for emulsification promotion 18 by injecting the emulsion fuel to the narrow space for emulsification promotion 18 which is almost in a closed state using the second nozzle 32 of the first negative pressure mixer 22, an agitator conventionally needed in the primary tank 10 can be eliminated, whereby the production cost for apparatus can be reduced.

In the present invention, the pump 60 can be continuously actuated, and the emulsion fuel can be continuously circulated through the main space 12 of the primary tank 10, the circulation passageway 28 (including the pump 60 and the rock storage container 62 on the way), the first negative pressure mixer 22, the space for emulsification promotion 18, and the main space 12 in the order. As a result, since the emulsion fuel can be made contact, in a short time, with a rock such as obsidian for a long time, an emulsion fuel that contains a large amount of dissolved oxygen and active hydrogen can be made in a short time. In addition, an emulsion fuel is circulated and made contact with rocks such as obsidian having many sharp edges formed on the surfaces many times, whereby the water and fuel making up the emulsion fuel are finely cut by a rock, thereby being capable of stabilizing the emulsified state. The emulsion fuel which is more finely cut by a rock to stabilize its emulsified state can ignite using a burner smoothly.

The emulsion fuel manufactured by the apparatus according to the present invention can be readily ignited, leading to complete combustion. As a result, CO₂ and NOₓ generated in combustion can be extremely reduced in their discharge amounts by complete combustion.

### EXAMPLE 2

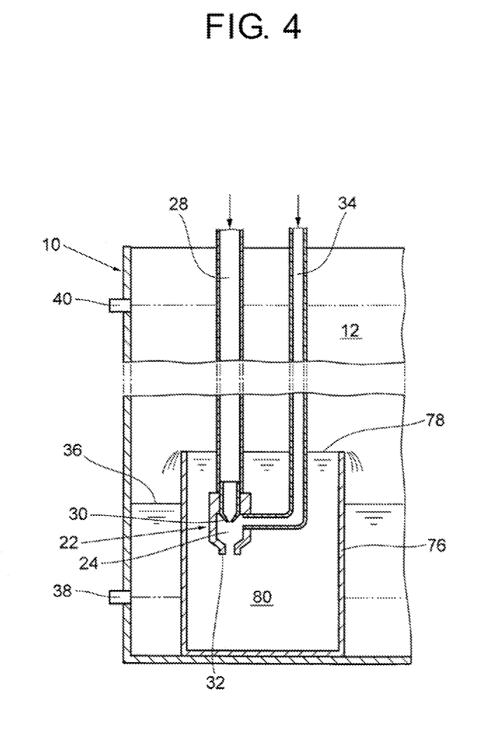

Next, a second example of the present invention will be described with reference to FIG. 4. The same reference numerals as in FIGS. 1 and 2 show the same members in FIG. 4. In FIG. 2, one edge of the space for emulsification promotion 18 always directly communicates with the main space 12. On the other hand, in the second example, the main space 12 of the primary tank 10 includes therein a small tank 76 as the secondary tank. The height of an upper opening 78 of the small tank 76 is set upward of the height of the lower limit sensor 38 and downward of the height of the upper limit sensor 40. The space inside the small tank 76 is a space for emulsification promotion 80. The space for emulsification promotion 80 includes therein the first negative pressure mixer 22. The reason why the space for emulsification promotion 80 includes therein the first negative pressure mixer 22 is that an emulsion fuel from the first negative pressure mixer 22 is injected into a narrow tank (container), whereby the emulsion fuel is mixed (agitated) without using an agitator. This is also because even if the primary tank 10 or the small tank 76 is inclined due to the inclination of the automobile, ship or the like, air is prevented from entering the inside of the first negative pressure mixer 22.

In FIG. 4, the liquid level 36 within the main space 12 of the primary tank 10 is located downward of the upper opening 78 of the small tank 76. Under such a condition, when the pump 60 (not shown in FIG. 4) is actuated, the emulsion fuel in the main space 12 reaches the first negative pressure mixer 22 via the circulation passageway 28 (rock storage container 62), and then the emulsion fuel is injected from the first negative pressure mixer 22 into the space for emulsification promotion 80 of the small tank 76. Since the space for emulsification promotion 80 of the small tank 76 is a closed space, the emulsion fuel within this space for emulsification promotion 80 and the emulsion fuel injected from the first negative pressure mixer 22 are agitated to promote emulsification. Since the emulsion fuel is supplied sequentially into the first negative pressure mixer 22 within the small tank 76 through the circulation passageway 28, the emulsion fuel overflows continuously from the upper opening 78 of the small tank 76 and falls to the main space 12 of the primary tank 10, so that the proportion of the emulsion fuel promoted in emulsification is increased within the main space 12. The emulsion fuel in the main space 12 is then circulated through the circulation passageway 28, the first negative pressure mixer 22, and the space for emulsification promotion 80 by actuation of the pump 60 and arrives again at the main space 12. The repetition of this circulation promotes the emulsification of the emulsion fuel.

In FIG. 4, although the height of the liquid level 36 within the primary tank 10 is set to be located downward of the upper opening 78 of the small tank 76, the height of the liquid level 36 within the primary tank 10 may be located upward of the upper opening 78 of the small tank 76. In this case, the emulsion fuel injected from the first negative pressure mixer 22 into the space for emulsification promotion 80 is extruded in a sequence to the main space 12 of the primary tank 10 from the upper opening 78 of the small tank 76, and then mixed with the emulsion fuel within the main space 12 of the primary tank 10. As a result, the proportion of the emulsion fuel promoted in emulsification is sequentially increased within the main space 12 of the primary tank 10.

In the second example of the present invention shown in FIG. 4 as well, the first negative pressure mixer 22 is disposed in the narrow, closed space for emulsification promotion 80 as in the first example of the present invention. Thus, the second example can also achieve the same advantages as the first example, so the descriptions of the advantages are omitted. In addition, although the second negative pressure mixer 68 is not shown in FIG. 4, the second negative pressure mixer 68 should be included.

In the descriptions of the first and second examples of the present invention, the oil is regarded as a fuel (fuel such as heavy oil, light oil, kerosene, or gasoline), and the emulsion is regarded as an emulsion fuel. The oils should include, in addition to fuels, petroleum-based dry solvents, waste oils, waste cooking oils, cooking oils, cosmetic oils, and the like. When the oil is a material except a fuel, the “fuel” should be replaced by an “oil” and the “emulsion fuel” by an “emulsion” in the above descriptions.

1. Emulsion manufacturing equipment comprising:
a primary tank having formed therein a main space for storing an emulsion;
a secondary tank having formed therein a space for emulsification promotion communicating with the main space;
a circulation passageway communicating with the main space at one end and for circulating and moving an emulsion within the main space;
transfer means provided in the middle of the circulation passageway and for moving the emulsion within the main space through the circulation passageway;
a liquid introduction channel communicating with a water tank and an oil tank at one end and passing water and oil; and
a first negative pressure mixer disposed within the space for emulsification promotion of the secondary tank, and comprising a mixing space communicating with another end of the circulation passageway and mixing the emulsion introduced from the circulation passageway with the water and oil introduced from another end of the liquid introduction channel, and a first nozzle injecting the emulsion from the circulation passageway to the mixing space to generate a negative pressure in the mixing space.

2. The emulsion manufacturing equipment according to claim 1, comprising:
a second negative pressure mixer comprising a housing, a mixing space formed inside the housing, a first nozzle for introducing the emulsion from the circulation passageway into the mixing space and an inlet communicating the mixing space to the outside of the housing, within the main space of the primary tank.

3. The emulsion manufacturing equipment according to claim 1, wherein the secondary tank comprises a container shape having an opening formed in the upper part, the secondary tank is disposed downward of the bottom of the primary tank, and the secondary tank is connected and fixed to the bottom of the primary tank at an upper opening edge thereof.

4. The emulsion manufacturing equipment according to claim 1, wherein the secondary tank comprises a container shape having an opening formed in an upper part thereof, and is disposed within the main space of the primary tank.

5. The emulsion manufacturing equipment according to claim 1, wherein the first negative pressure mixer comprises a second nozzle for injecting an emulsion mixed within the mixing space into the space for emulsification promotion.

6. The emulsion manufacturing equipment according to claim 1, wherein the main tank comprises a lower limit sensor and an upper limit sensor, each sensor detecting the liquid level of an emulsion within the main space.

7. The emulsion manufacturing equipment according to claim 1, wherein the liquid introduction channel comprises a water supply channel, an oil supply channel and an emulsifier supply channel which are branched on the way, wherein the water supply channel communicates with the water tank, the oil supply channel communicates with the oil tank which stores oil, the emulsifier supply channel communicates with the emulsifier tank, the water supply channel comprises a first on-off valve in the middle thereof which opens or closes the supply channel, the oil supply channel comprises a second on-off valve in the middle thereof which opens or closes the supply channel, and the emulsifier supply channel comprises a third on-off valve in the middle thereof which opens or closes the supply channel.

8. The emulsion manufacturing equipment according to claim 1, comprising:
a rock storage container storing therein a rock containing 65 to 76% silicon dioxide of igneous rocks downstream of the transfer means in the middle of the circulation passageway.

9. The emulsion manufacturing equipment according to claim 8, wherein the sizing of most rocks containing 65 to 76% silicon dioxide of the igneous rocks is from 5 mm to 50 mm.

10. The emulsion manufacturing equipment according to claim 8, wherein the rock containing 65 to 76% silicon dioxide of the igneous rocks includes obsidian.

11. The emulsion manufacturing equipment according to claim 2, wherein the secondary tank comprises a container shape having an opening formed in the upper part, the secondary tank is disposed downward of the bottom of the primary tank, and the secondary tank is connected and fixed to the bottom of the primary tank at an upper opening edge thereof.

12. The emulsion manufacturing equipment according to claim 2, wherein the secondary tank comprises a container shape having an opening formed in an upper part thereof, and is disposed within the main space of the primary tank.

13. The emulsion manufacturing equipment according to claim 2, wherein the first negative pressure mixer comprises a second nozzle for injecting an emulsion mixed within the mixing space into the space for emulsification promotion.

14. The emulsion manufacturing equipment according to claim 2, wherein the main tank comprises a lower limit sensor and an upper limit sensor, each sensor detecting the liquid level of an emulsion within the main space.

15. The emulsion manufacturing equipment according to claim 2, wherein the liquid introduction channel comprises a water supply channel, an oil supply channel and an emulsifier supply channel which are branched on the way, wherein the water supply channel communicates with the water tank, the oil supply channel communicates with the oil tank which stores oil, the emulsifier supply channel communicates with the emulsifier tank, the water supply channel comprises a first on-off valve in the middle thereof which opens or closes the supply channel, the oil supply channel comprises a second on-off valve in the middle thereof which opens or closes the supply channel, and the emulsifier supply channel comprises a third on-off valve in the middle thereof which opens or closes the supply channel.

16. The emulsion manufacturing equipment according to claim 2, comprising:
a rock storage container storing therein a rock containing 65 to 76% silicon dioxide of igneous rocks downstream of the transfer means in the middle of the circulation passageway.

17. The emulsion manufacturing equipment according to claim 9, wherein the rock containing 65 to 76% silicon dioxide of the igneous rocks includes obsidian.
